(19) United States
(12) Patent Application Publication
(10) Pub. No.: US 2009/0277073 A1
(43) Pub. Date: Nov. 12, 2009

(54) Insect-trapping apparatus

(76) Inventor: Juei-Chao Chen, Taipei City (TW)

Correspondence Address: Juei-Chao, CHEN, P.O. BOX 46-563 Taipei, Taipei City, 104, TW

(21) Appl. No.: 12/229,861

(22) Filed: Aug. 28, 2008

(30) Foreign Application Priority Data
May 9, 2008 (TW) 097208077

(51) Int. Cl. A01M 1/22; A01M 1/04

(52) U.S. Cl. 43/112; 43/113

(57) ABSTRACT

An insect-trapping apparatus attracts insects with different phototaxis characteristics through a light emitting element of different wavelengths disposed on an inner side of a base, and absorbs and converts the light energy of the light emitting element to electric energy through the solar plate disposed on an inner surface of the base. This electric energy is provided as an alternative electric supply for the light emitting element and the electric mesh on an outer surface of the base, thereby achieving the goal of recycled power use, energy conservation, and trapping and killing insects.

### BACKGROUND OF THE INVENTION

1. Technical Field

The present invention is related to devices for trapping insects, and particularly, to an insect-trapping apparatus which provides different wavelengths for trapping insects with reduced power consumption.

2. Description of Related Art

Summer is typically the peak season where insects are active and highly reproductive. Besides unpleasant mosquito bites on human body, possible bacteria carried by the insects may be transmitted to human body at the same time. Therefore, it has been a problem of top priority to control and kill insects in summer time. Generally, insects prevention can be employed through the use of pesticide spray, mosquito coil incense, electric swatters, mosquito lamps, etc., and among which, pesticide spray and mosquito coil incense achieve faster results, but if exceedingly inhaled can cause harm to human body; electric swatters are easy to use, but the ease of use can be a danger exposed to curious children who might unawarely touch the electric net. As a result, mosquito lamps are more often used as insect prevention devices. As shown in FIG. 1, the structure of a conventional mosquito lamp 1 includes a base 11 in which multiple electric meshes 12 and a lamp 13 are disposed. When current is conducted through the mosquito lamp 1, insects, because of their phototaxis characteristics, are attracted by the light emitted by the lamp 13, and killed as they touch the multiple electric meshes 12 disposed on the outside of the lamp 13, thereby achieving the goal of insect control. However, the conventional mosquito lamp 1 uses the lamp 13 or a light bulb as its light source, and since different insects demonstrate highly different phototaxis characteristics in response to light sources with different wavelengths, the single wavelength lamp 13 of the conventional lamp 1 is limited in its effectiveness in killing insects. On the other hand, when operated for an extended period of time, the lamp 1 consumes a considerable amount of electricity and the cost associated with it, which is neither environment-friendly nor economical, and hence improvement needs to be sought.

Therefore, problems mentioned above are the technical difficulties to be resolved in the present invention.

### BRIEF SUMMARY OF THE INVENTION

In view of the aforementioned drawbacks, with related data collected, evaluation and consideration given from different perspectives, and years of experience in this field, and after repetitive experiments and modifications, an energy storing device for trapping insects by providing different wavelengths is construed.

The primary purpose of the present invention is: by emitting light of different wavelengths by respective light emitting elements, different kinds of insects are attracted to approach and touch the electric mesh, thereby achieving the effectiveness of killing the insects.

The secondary purpose of the present invention is: a light emitting element mentioned above is disposed in the retaining space of the base, and at least one solar plate is disposed on the inner surface of the base, such that when the disclosed device is operated, the solar plate simultaneously absorbs the electric energy converted from light emitted by the lighting element, for use as an alternative source of power supply, thereby achieving the goal of recycled power use and energy conservation.

Another purpose of the present invention is: a protective device disposed on outermost to the retaining space is comprised from multiple vanes with adjustable angle, such that when the mosquito lamp is operated, if light is perceived to be blinding, an adjustment of angle of the protective device can be made according to need to achieve convenient use.

### BRIEF DESCRIPTION OF THE SEVERAL VIEWS OF THE DRAWINGS

The structure and technical means adopted by the present invention to achieve the above objectives and effects can be best understood by referring to the following detailed description of features and functions of preferred embodiments in conjunction with the accompanying drawings, wherein:

FIG. 1 is a perspective view of a prior art device;

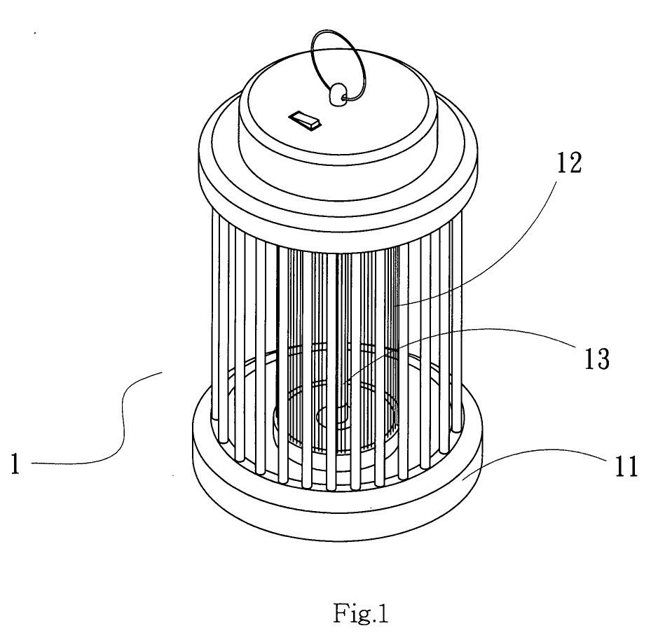

FIG. 2 is an exploded view of the prior art device;

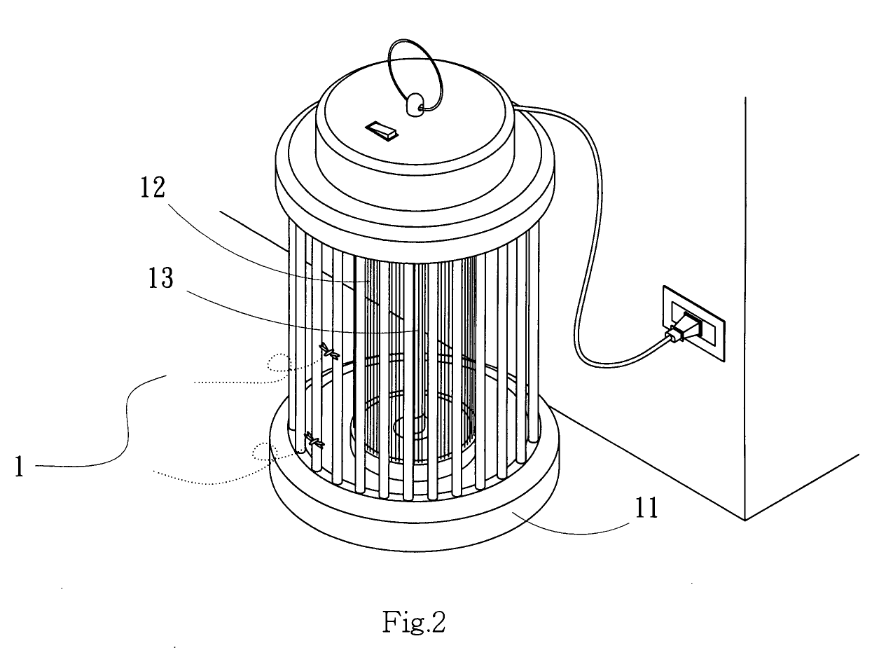

FIG. 3 is a perspective view of a first embodiment of the present invention;

FIG. 4 is an exploded view of the first embodiment of the present invention;

FIG. 5 is a partial schematic view showing a multiple light emitting elements of the present invention;

FIG. 6 shows an applied view of the first embodiment of the present invention;

FIG. 7 shows another applied view of the first embodiment of the present invention;

FIG. 8 shows a second embodiment of the present invention;

FIG. 9 also shows the second embodiment of the present invention; and

FIG. 10 shows an applied view of the second embodiment of the present invention.

### DETAILED DESCRIPTION OF THE INVENTION

In order to achieve the forgoing purposes and effects, the technical means and structure of the present invention are described in detail of by way of preferred embodiments of the present invention and the features and functions thereof, accompanied with drawings to facilitate full understanding.

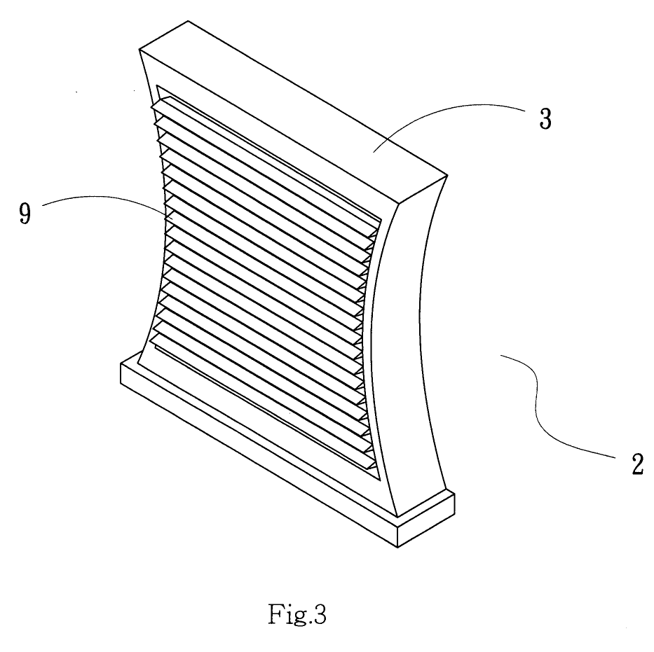

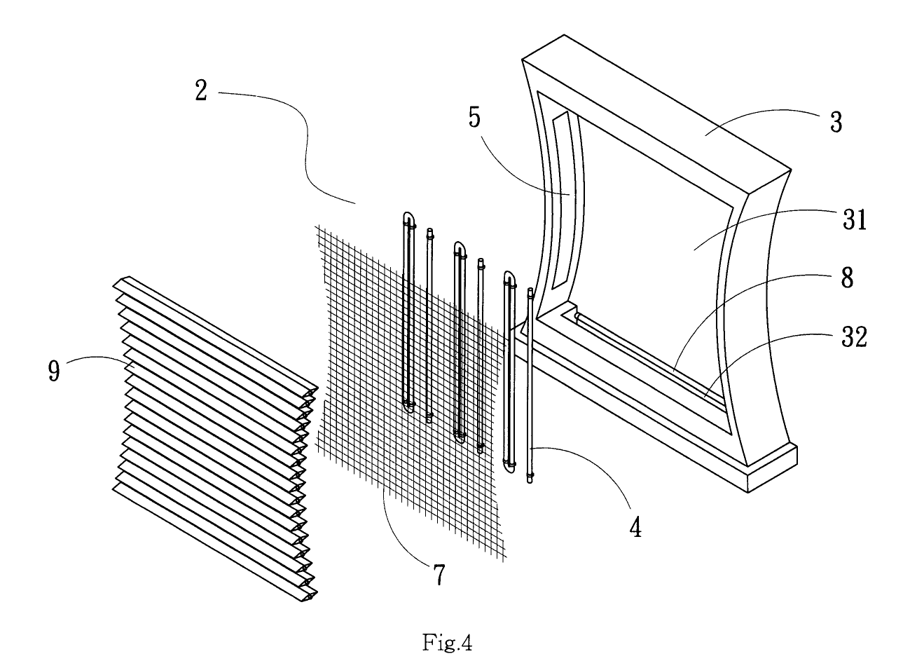

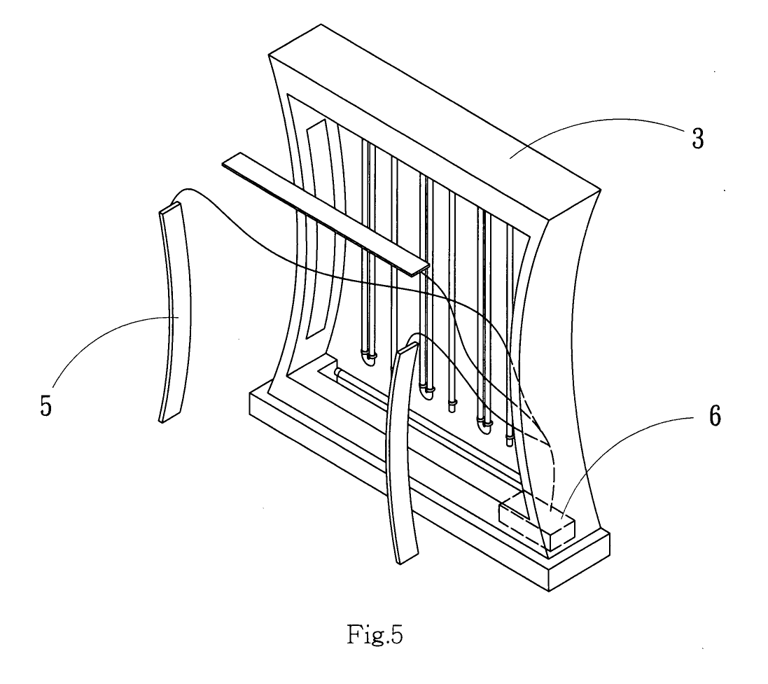

As can be clearly seen in FIG. 3, FIG. 4 and FIG. 5, the insect-trapping apparatus 2 essentially comprises a base 3, one or more light emitting elements 4, at least one solar plate 5, an energy storing device 6, an electric mesh 7 and an protective device 9. The base 3 is formed with a retaining space 31. Said retaining space 31 has a collection trench 32. The multiple light emitting elements 4 of different wavelengths between 300 mm to 400 mm are disposed on the lower side of the retaining space 31. The at least one solar plate 5 having a specification associated with a monocrystalline silicon solar plate, a polycrystalline silicon or an amorphous silicon is disposed the inner surface thereof, and is interconnected with the energy storing device 6 which stores electric energy associated with a nickel-metal-hydride battery, a nickel-cadmium battery, a hydrocarbon battery or a lithium cell. The electric mesh 7 is also disposed in the retaining space 31. A vane-based protective device 9 is disposed on the outermost thereof, and at least one ultraviolet lamp 8 is disposed in the collection trench 32 on the lower side of the retaining space 31.

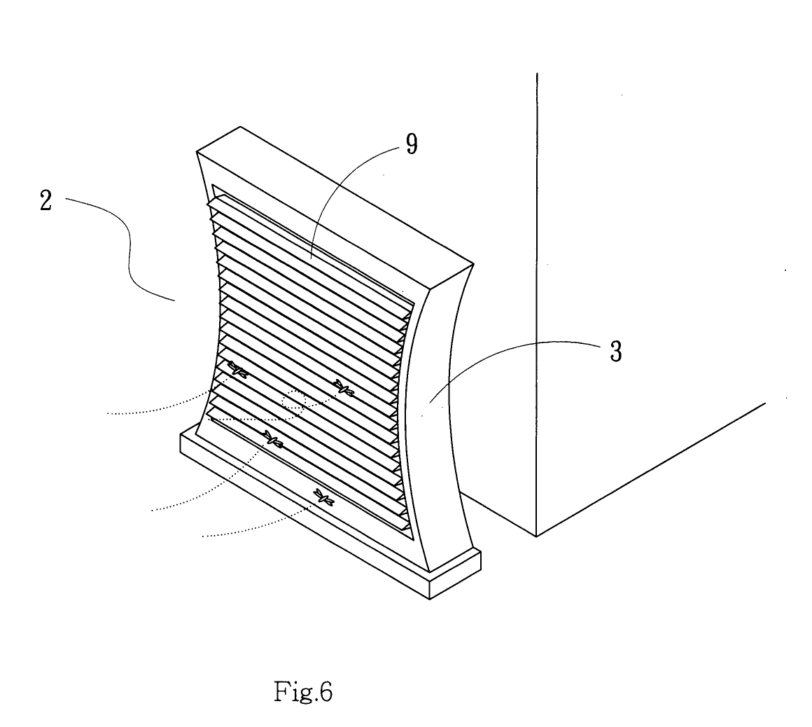

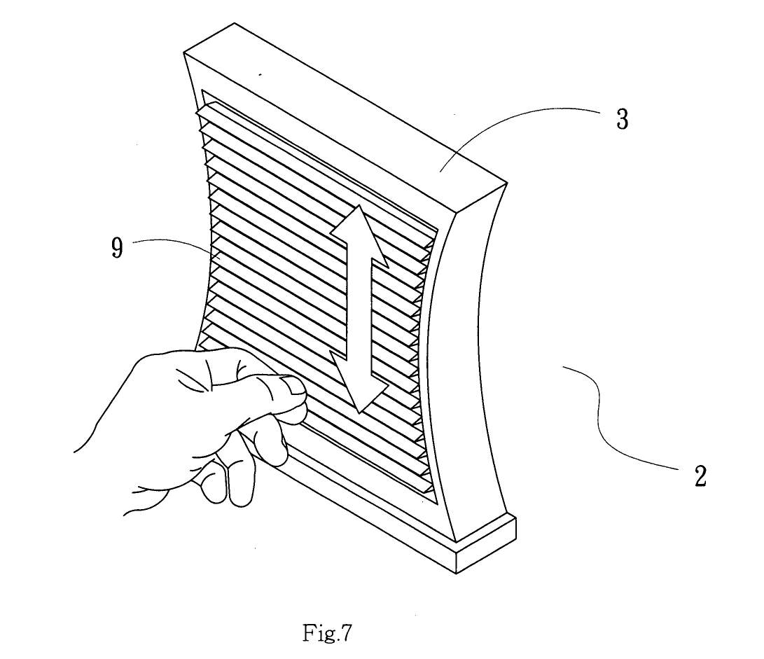

Referring to FIG. 6 and FIG. 7 (also referring to FIG. 4 and FIG. 5), as can be clearly seen in the figures, when the insect-trapping apparatus 2 is used to catch insects, through the multiple solar plates 5 disposed on the inner wall of the retaining space 31 of the base 3, light energy emitted by the multiple light emitting elements 4 are absorbed and converted to electric energy to be stored in an energy storing device 6, such that the energy storing device 6 can be used as an alternative source of power supply of the insect-trapping apparatus 2, enabling the insect-trapping apparatus 2 to achieve energy storing, recycled power use and environment conservation. Further, due to the multiple light emitting elements 4 of wavelengths between 300 mm to 400 mm disposed in the retaining space 31 of the base 3, and the phototaxis characteristics of the insects, different kinds of insects can be attracted to and killed by the electric mesh 7. The ultraviolet lamp 8 is disposed in the collection trench 32 on the lower side of the retaining space 31, such that as the dead insects drop into the collection trench 32, bacteria is prevented from growing by the radiation off the ultraviolet lamp 8. Furthermore, the protective device 9 disposed outermost to the retaining space 31 of the insect-trapping apparatus 2 is a structure comprised from multiple vanes, the angle of which is adjustable according to needs, preventing children from sticking their fingers in to unawarely touch the electric mesh 7. Also, since the insect-trapping apparatus 2 is mostly used at night and during the sleep hours, if excessive amount of light is perceived from the insect-trapping apparatus 2, angle of illumination can be adjusted through the protective device 9 to achieve convenient use.

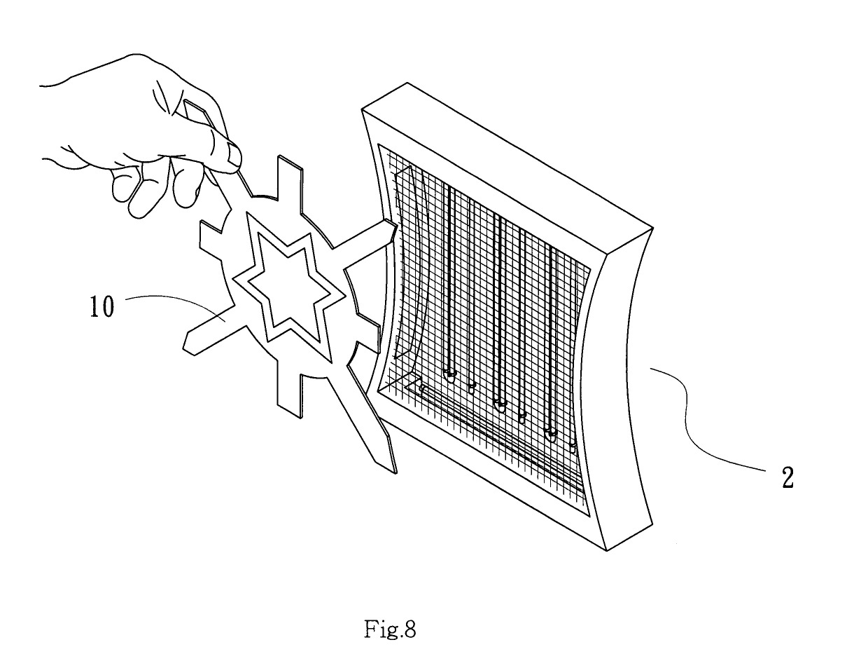

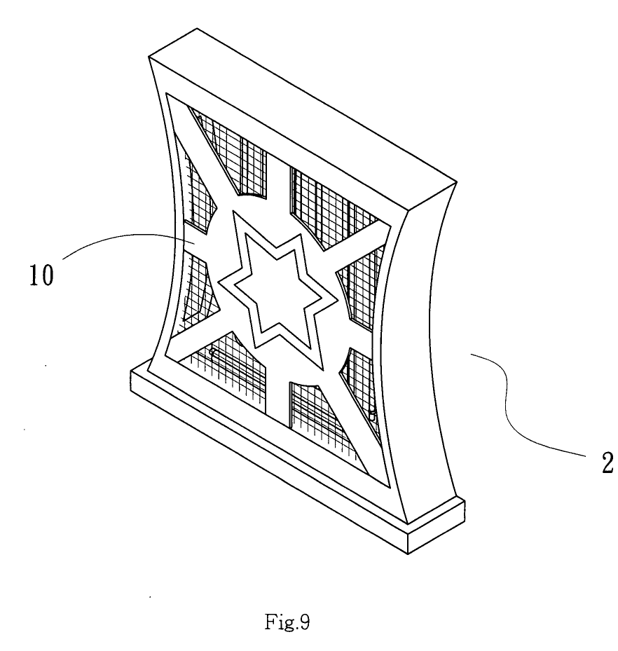

Referring to FIG. 8 and FIG. 9, which show figures of a further embodiment of the present invention. As can be clearly seen in the figures, the insect-trapping apparatus 2 can be selectively equipped with a protective device 10 made of a transparent or translucent plate structure, which can be replaced by protective devices 10 with different patterns or textures, so as to fit the home environment and provide nice appearance besides trapping the insects.

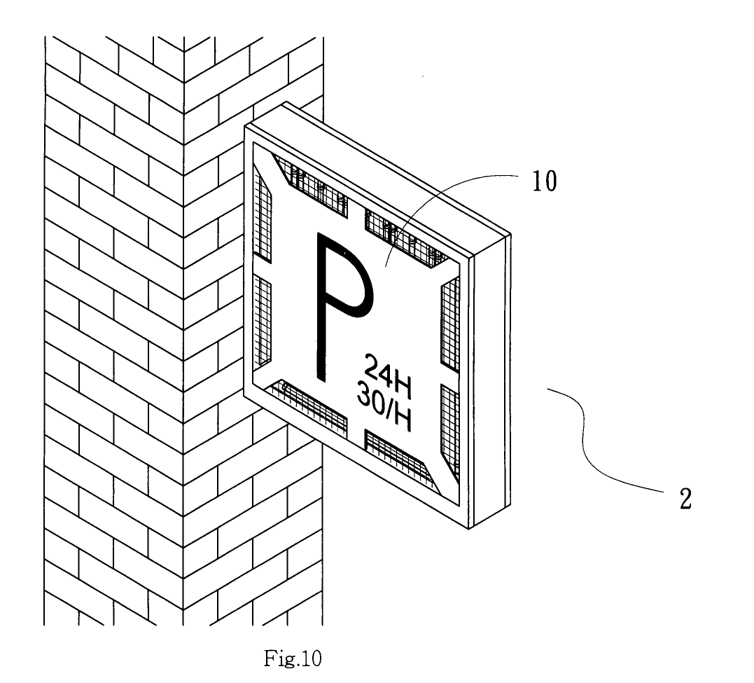

Referring to FIG. 10, which shows a figure according to the further embodiment of the present invention. As can be clearly seen in the figure, the insect-trapping apparatus 2 can be selectively equipped with a protective device 10 made of a transparent or translucent plate structure, on which words or patterns can be drawn for marking, advertisement or indication purposes.

1. An insect-trapping apparatus, comprising:
a base, formed with a retaining space;
at least one light emitting element, disposed in said retaining space of said base;
an electric mesh, disposed in said retaining space;
a protective device, disposed outermost in said retaining space.

2. The insect-trapping apparatus of claim 1, wherein said light emitting element comprises lighting units having at least two different wavelengths.

3. The insect-trapping apparatus of claim 1, wherein a collection trench is disposed at a bottom of said retaining space.

4. The insect-trapping apparatus of claim 3, wherein one or more ultraviolet lamps are disposed in said collection trench.

5. The insect-trapping apparatus of device of claim 1, wherein a solar plate is disposed on the inner surface of said retaining space and connected to a storage device for storing electric energy converted from light collected by said solar plate.

6. The insect-trapping apparatus of claim 1, wherein said protective device is a transparent or translucent plate structure with patterns or texture drawn thereon.

7. The insect-trapping apparatus of claim 1, wherein said protective device is of a vane style having an adjustable angle.

8. An insect-trapping apparatus, comprising: a base; one or more light emitting elements; at least one solar plate; an energy storing device; an electric mesh; and a protective device, wherein said base is formed with a retaining space, and said light emitting elements, electric mesh and energy storing device are disposed together therein, while said solar plate is disposed on an inner wall thereof and a protective device is further disposed outermost thereof, being characterized by: said protective device being made of a plurality of vanes of adjustable angle.

9. The insect-trapping apparatus of claim 8, wherein said light emitting elements comprise lighting units having at least two different wavelengths.

10. The insect-trapping apparatus of claim 8, wherein said energy storing device is a nickel-metal-hydride battery, a nickel-cadmium battery, a hydrocarbon battery or a lithium cell.

11. The insect-trapping apparatus of claim 8, wherein said solar plate is a monocrystalline silicon solar plate, a polycrystalline silicon solar plate or an amorphous silicon solar plate.
